(19) United States
(12) Patent Application Publication
(10) Pub. No.: US 2025/0328874 A1
(43) Pub. Date: Oct. 23, 2025

(54) PAYMENT GATEWAY SERVICE SYSTEM AND SERVICE METHOD LINKED TO A BILL BASED ON QUICK RESPONSE CODE

(71) Applicant: ESTORM CO., LTD., Seoul (KR)

(72) Inventor: Jong Hyun WOO, Seoul (KR)

(21) Appl. No.: 18/870,918

(22) PCT Filed: May 20, 2024
(86) PCT No.: PCT/KR2024/006812

§ 371 Date: Dec. 2, 2024

(30) Foreign Application Priority Data
May 18, 2023 (KR) 10-2023-0064222
May 20, 2024 (KR) 10-2024-0065478

(51) Int. Cl. G06Q 20/02; G06Q 20/32

(52) U.S. Cl. CPC G06Q 20/027; G06Q 20/3274

(57) ABSTRACT

A QR code-based bill-linked PG service system and service method for enabling a payer to check a QR code-based bill with his or her smartphone and make payment through a PG linked to the bill. The system includes a service terminal for receiving billing information and requesting generation of an open bill in form of a QR code, a payment server generating the requested open bill and providing the requested open bill to the service terminal, and a smartphone-type payer terminal scanning the open bill displayed on the service terminal. The payment server verifies a payment bill linked to the open bill when the payer terminal scans the open bill, and then allows a mobile PG service to be displayed on the payer terminal such that a payer is able to make mobile payment using a service of a payment company desired by the payer.

### CROSS-REFERENCE TO RELATED APPLICATIONS

This application is a National Stage Entry of International Patent Application No. PCT/KR2024/006812, filed on May 20, 2024, which claims priority from and the benefit of Korean Patent Application No. 10-2023-0064222, filed on May 18, 2023, and Korean Patent Application No. 10-2024-0065478, filed on May 20, 2024, each of which is hereby incorporated by reference for all purposes as if fully set forth herein.

### BACKGROUND

### Field

Embodiments of the invention relate generally to a Quick Response (“QR”) code-based bill-linked Payment Gateway (“PG”) service system and service method, and more specifically, to a QR code-based bill-linked PG service system and service method for enabling a payer to check a QR code-based bill with his or her smartphone and make payment through a PG linked to the bill including the same, and a method for driving thereof.

### Discussion of the Background

A typical PG is a business that acts as a payment gateway such that an online shopping mall does not directly receive a customer's credit card number and an intermediary business with a high level of trust makes credit card payments and forwards payment results to the online shopping mall for payment.

Using PG online corresponds to a case in which, when a payer knows which online shopping mall (hereinafter referred to as the “collector”) he/she is dealing with on his/her terminal and checks a bill to confirm the purchase history, the payer proceeds with the payment through a PG company connected by the online shopping mall.

In other words, there is no need to check the billing details (collector and payment amount) separately because the payment is made through the PG after checking the billing details of the online shopping mall used.

In addition, in the process of card payment through PG, a method of scanning a QR code with a smartphone is performed. In this case, a user chooses which card company (or payment company) to pay with in advance in PG, and then the payment is approved by scanning a QR code displayed by a corresponding card company in the mobile app of the same card company, where the QR code is used to verify that the payer has correct payment authentication means.

However, unlike online situations, paying with an app card offline is not as easy as it is in online. It is difficult for restaurants to ask the customers in advance which payment app they want to pay with, and it is also difficult for the customers to approve payment on their smartphones without checking the contents of the QR code requesting payment, thus making it easy to fall prey to a QR code substitution attack called “QRishing”.

In this situation, there is a need for a technology that allows a payer to check the details of payment through his/her smartphone without notifying or selecting a payment app installed on his/her smartphone in advance when a payer proceeds with payment using his/her smartphone and make payment safely through the payment app already installed on his/her smartphone.

The above information disclosed in this Background section is only for understanding of the background of the inventive concepts, and, therefore, it may contain information that does not constitute prior art.

### SUMMARY

A QR code-based bill-linked PG service system and service method according to embodiments of the invention enables a payer to check a QR code-based bill with his or her smartphone and make payment through a PG linked to the bill.

One or more embodiments of the invention include a QR code-based bill-linked PG service system including: a service terminal configured to receive billing information and request generation of an open bill in a form of a QR code; a payment server configured to generate the requested open bill and provide the requested open bill to the service terminal; and a smartphone-type payer terminal configured to scan the open bill displayed on the service terminal. The payment server is configured to verify a payment bill linked to the open bill when the payer terminal scans the open bill, and then allow a mobile PG service to be displayed on the payer terminal such that a payer is able to make mobile payment using a service of a payment company desired by the payer. The to an embodiment, the payment server may include: a generation section configured to generate the open bill in the form of a QR code; a communication section configured to receive the billing information from the service terminal and provide the open bill to the service terminal; and a payment section configured to provide the PG service when the payer terminal scans the above open bill.

The billing information may include a payment amount and service provider information.

The payment section may include an inquiry unit configured to display the payment bill including the payment amount and service provider information corresponding to the open bill on the payer terminal; a list unit configured to list and display one or more of payment companies which the payer is able to pay with, including card companies, banks, financial transaction providers, and virtual currency transaction providers; and a payment unit configured to make payment through a service of a payment company selected by the payer.

The list unit may list the payment companies according to a default language of a browser set in the payer terminal or a language corresponding to a Global Positioning System (“GPS”) location of the payer terminal.

One or more embodiments of the invention include a QR code-based bill-linked PG service method including: requesting, by a service provider, an open bill in a form of a QR code through a service terminal; providing, by a payment server, the open bill to the service terminal; calling, by a payer terminal, a PG service by scanning the generated open bill; and making payment through a service of a payment company desired by the payer using the called PG service.

By the service provider, the open bill in the form of the QR code through the service terminal may include: logging in, by the service provider, to a payment app; and requesting the open bill by inputting the billing information to the payment app.

The providing, by the payment server, the open bill to the service terminal may include: receiving, by the payment server, the billing information from the service terminal; generating the open bill in the form of the QR code according to the billing information provided; and providing and displaying the generated open bill to and on the service terminal.

The making payment through the service of the payment company desired by the payer using the called PG service may include: making an inquiry for a payment bill containing a payment amount and service provider information corresponding to the scanned open bill; displaying the inquired payment bill on the payer terminal; displaying, on the payer terminal, a list of payment companies that the payer is able to use, including card companies, banks, and PG companies; requesting, by the payer, a payment page to the selected payment company; and requesting, by the payer, payment to the payment company through the payment page and making payment.

In displaying, on the payer terminal, the list of payment companies that the payer is able to use, including card companies, banks, and PG companies may include listing the payment companies according to a default language of a browser set in the payer terminal or a language corresponding to a GPS location of the payer terminal.

In making an inquiry for a payment bill containing a payment amount and service provider information corresponding to the scanned open bill, the payment amount of the payment bill may be equally divided according to a number of payers entered in the payment app.

In making an inquiry for a payment bill containing a payment amount and service provider information corresponding to the scanned open bill, the payment amount of the payment bill may be provided in a divided manner according to a billing amount for each payer entered in the payment app.

In calling, by the payer terminal, a PG service by scanning the generated open bill, the open bill may be arranged to be viewed by only a number of payers entered.

Additional features of the inventive concepts will be set forth in the description which follows, and in part will be apparent from the description, or may be learned by practice of the inventive concepts.

It is to be understood that both the foregoing general description and the following detailed description are illustrative and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the inventive concepts.

FIG. 1 is a diagram showing an example of a configuration of a QR code-based bill-linked PG service system according to an embodiment of the invention.

FIG. 2 is a configuration diagram of a QR code-based bill-linked PG service system according to an embodiment of the invention.

FIG. 3 is a flowchart of processes of a QR code-based bill-linked PG service system according to an embodiment of the invention.

FIG. 4 is a diagram showing an example of a service screen according to an embodiment of the invention.

FIG. 5 is a flowchart of a QR code-based bill-linked PG service method according to an embodiment of the invention.

FIG. 6 is a flowchart of a step of requesting, by a service provider, an open bill in a form of a QR code through a service terminal according to an embodiment of the invention.

FIG. 7 is a flowchart of a step of providing, by the payment server, an open bill to the service terminal according to an embodiment of the invention.

FIG. 8 is a flowchart of a step in which payment is made through the service of a payment company desired by a payer using the called PG service according to an embodiment of the invention.

### DETAILED DESCRIPTION

In the following description, for the purposes of explanation, numerous specific details are set forth in order to provide a thorough understanding of various embodiments or implementations of the invention. As used herein “embodiments” and “implementations” are interchangeable words that are non-limiting examples of devices or methods employing one or more of the inventive concepts disclosed herein. It is apparent, however, that various embodiments may be practiced without these specific details or with one or more equivalent arrangements. In other instances, well-known structures and devices are shown in block diagram form in order to avoid unnecessarily obscuring various embodiments. Further, various embodiments may be different, but do not have to be exclusive. For example, specific shapes, configurations, and characteristics of an embodiment may be used or implemented in another embodiment without departing from the inventive concepts.

Unless otherwise specified, the illustrated embodiments are to be understood as providing features of varying detail of some ways in which the inventive concepts may be implemented in practice. Therefore, unless otherwise specified, the features, components, modules, layers, films, panels, regions, and/or aspects, etc. (hereinafter individually or collectively referred to as “elements”), of the various embodiments may be otherwise combined, separated, interchanged, and/or rearranged without departing from the inventive concepts.

Although the terms “first,” “second,” etc. may be used herein to describe various types of elements, these elements should not be limited by these terms. These terms are used to distinguish one element from another element. Thus, a first element discussed below could be termed a second element without departing from the teachings of the disclosure.

Spatially relative terms, such as “beneath,” “below,” “under,” “lower,” “above,” “upper,” “over,” “higher,” “side” (e.g., as in “sidewall”), and the like, may be used herein for descriptive purposes, and, thereby, to describe one elements relationship to another element(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof. It is also noted that, as used herein, the terms “substantially,” “about,” and other similar terms, are used as terms of approximation and not as terms of degree, and, as such, are utilized to account for inherent deviations in measured, calculated, and/or provided values that would be recognized by one of ordinary skill in the art.

As is customary in the field, some embodiments are described and illustrated in the accompanying drawings in terms of functional blocks, units, and/or modules. Those skilled in the art will appreciate that these blocks, units, and/or modules are physically implemented by electronic (or optical) circuits, such as logic circuits, discrete components, microprocessors, hard-wired circuits, memory elements, wiring connections, and the like, which may be formed using semiconductor-based fabrication techniques or other manufacturing technologies. In the case of the blocks, units, and/or modules being implemented by microprocessors or other similar hardware, they may be programmed and controlled using software (e.g., microcode) to perform various functions discussed herein and may optionally be driven by firmware and/or software. It is also contemplated that each block, unit, and/or module may be implemented by dedicated hardware, or as a combination of dedicated hardware to perform some functions and a processor (e.g., one or more programmed microprocessors and associated circuitry) to perform other functions. Also, each block, unit, and/or module of some embodiments may be physically separated into two or more interacting and discrete blocks, units, and/or modules without departing from the scope of the inventive concepts. Further, the blocks, units, and/or modules of some embodiments may be physically combined into more complex blocks, units, and/or modules without departing from the scope of the inventive concepts.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and should not be interpreted in an idealized or overly formal sense, unless expressly so defined herein.

Hereinafter, the invention will be described with reference to the accompanying drawings. The invention may, however, be embodied in many different forms and should not be construed as limited to the embodiments set forth herein. In order to clearly explain the present invention in the drawings, parts not related to the description are omitted, and like reference numerals refer to like elements throughout the specification.

Throughout the specification, when a part is said to be “connected (connected, contacted, joined)” to another part, this includes not only cases where it is “directly connected,” but also cases where it is “indirectly connected” with another part in between. In addition, unless explicitly described to the contrary, the word “comprise” and variations such as “comprises” or “comprising” will be understood to imply the inclusion of stated elements but not the exclusion of any other elements.

In addition, when a step is referred to herein as being “before” or “after” another step, this includes the same rights as if the step were in a direct chronological relationship with the other step, but also as if the step were in an indirect chronological relationship where the order of the two steps could be reversed, such as a mixing step after each step.

Hereinafter, embodiments of the invention will be described in detail with reference to the accompanying drawings.

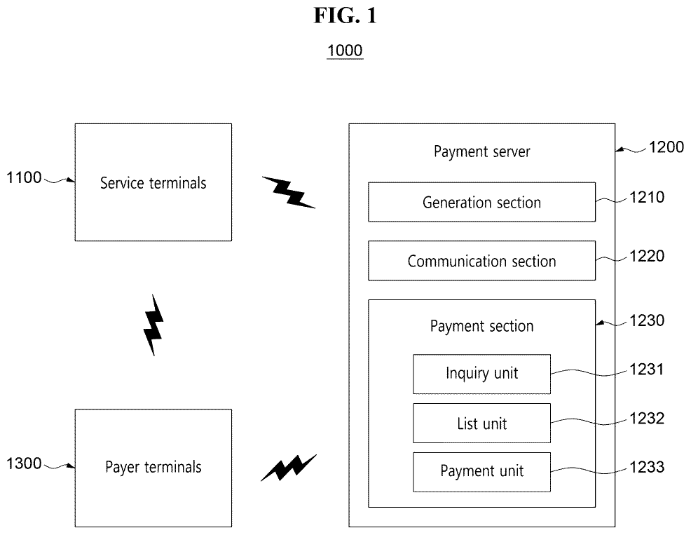

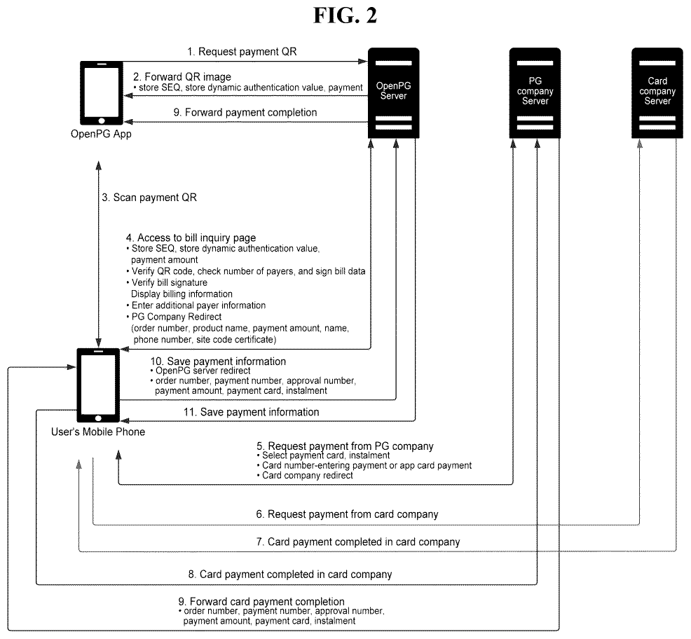

FIG. 1 is a diagram showing an example of a configuration of a QR code-based bill-linked PG service system according to an embodiment of the invention, and FIG. 2 is a configuration diagram of a QR code-based bill-linked PG service system according to an embodiment of the invention.

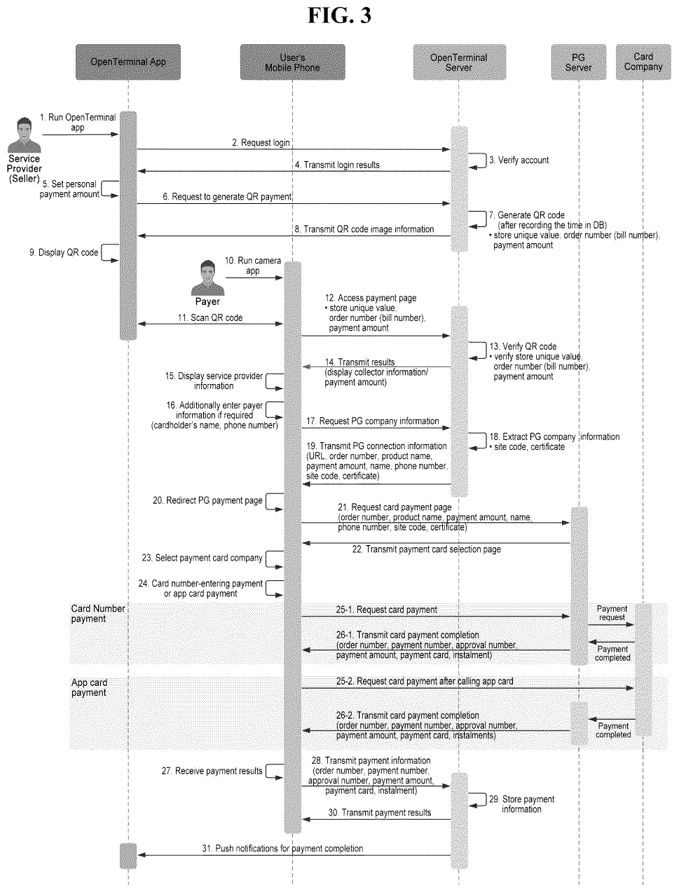

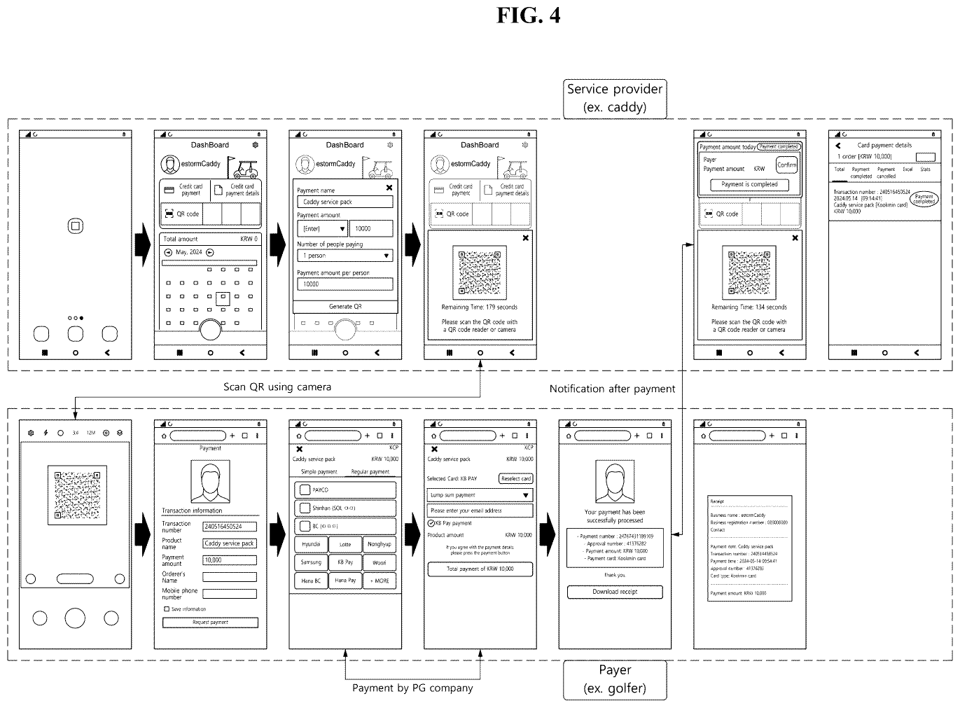

FIG. 3 is a flowchart of processes of a QR code-based bill-linked PG service system according to an embodiment of the invention, and FIG. 4 is a diagram showing an example of a service screen according to an embodiment of the invention.

Referring to FIGS. 1 to 3, a QR code-based bill-linked PG service system 1000 may include service terminals 1100, a payment server 1200, and payer terminals 1300.

A service terminal 1100 may be arranged to request the payment server 1200 to generate an open bill in a form of a QR code when billing information is input to the service terminal 1100.

In this case, the service terminal 1100 may be a hardware device such as a smartphone, kiosk, or tablet held by a store or an individual offline.

In addition, the billing information input into the service terminal 1100 may be arranged to include payment amount, service provider information, number of payers, and billing amount by number of payers. In this case, it may be provided to recognize that the billing amount by number of payers is equal when the billing amount by number of payers is blank.

A payer terminal 1300 may be arranged in a form of a smartphone that scans the open bill displayed on the service terminal.

The payment server 1200 may be arranged to generate the requested open bill and provide the open bill to the service terminal 1100. In this case, the payment server may be arranged to allow a payer to check a payment bill linked to the open bill when the payer terminal 1300 scans the open bill, and then display a mobile PG service on the payer terminal 1300 such that the payer can make mobile payment using the service of the payment company of his or her choice.

Specifically, the payment server 1200 may include a generation section 1210, a communication section 1220, and a payment section 1230.

The generation section 1210 may be arranged to receive the billing information and generate the open bill in the form of a QR code.

The communication section 1220 may be arranged to receive the billing information input from the service terminal 1100 and provide the open bill to the service terminal 1100.

In addition, the communication section 1220 may be arranged to enable communication between the payment server 1200 and the payer terminal 1300, such as providing the payment bill saved in the payment server 1200 to the payer terminal, when the payer terminal 1300 scans the open bill, communication between the payment server 1200 and the payment company's service, or the like.

The payment device 1230 may be arranged to provide the PG service when the payer terminal 1300 scans the open bill.

More specifically, the payment device 1230 may include an inquiry unit 1231, a list unit 1232, and a payment unit 1233.

The inquiry unit 1231 may be arranged to make an inquiry for the payment bill corresponding to the open bill to the payer terminal 1300 and provide the payment bill to be displayed on the payer terminal 1300.

In this case, information provided in the payment bill may include the total payment amount, the amount to be paid by each payer, and the service provider information.

In addition, the payment bill may further include a field for entering the payer's name and phone number, and a confirmation button for payment may be provided such that the payer is able to proceed with payment after confirming the information.

This payment bill may be arranged in the form of a mobile bill to be displayed directly on the web without installing a separate app.

The list unit 1232 may be arranged to list and display payment companies that the payer is able to pay, such as card companies, banks, and PG companies.

In particular, the list unit 1232 may be arranged to list payment companies according to the default language of a browser set in the payer terminal 1300 or a language corresponding to the GPS location of the payer terminal.

For example, the list unit 1232 may be arranged to automatically list and display payment companies capable of making payments in China when the GPS location of the payer terminal 1300 is in the United States.

In addition, the list unit 1232 may be arranged to list Korean payment companies capable of making payments in priority when the default language of the browser is Korean, even when the GPS location of the payer terminal 1300 is in the United States.

In this way, the list unit 1232 may enable the payer to select a payment company that he/she wants to use.

The payment unit 1233 may be arranged to guide a payer to proceed with payment through the service of the payment company selected by the payer.

Specifically, when the payer selects a desired payment company from the list unit 1232, the payment unit 1233 may be arranged to exchange payment-related information with a corresponding payment company such that the payer is able to make payment by utilizing the service of the payment company, such as an app.

For example, when the payer selects payment with a KB card from the list unit 1232, the payment unit 1233 may provide payment information to KB to enable payment to be made through the KB app installed on the payer terminal 1300.

Hereinafter, a QR code-based bill-linked PG service method will be specifically described according to the flow sequence illustrated in FIG. 3.
(1) In order to use the QR code-based bill-linked PG service system and service method of the present invention, first, a service provider (seller) runs the OpenTerminal App according to the invention.
(2) After running the OpenTerminal App, the ID and PW of the service provider (seller) are used to request a login to the OpenTerminal server. The ID and PW of the service provider (seller) should be entered at the time of the first login, but if the same user runs the OpenTerminal App on the same mobile terminal thereafter, the corresponding information may be saved as a cookie to enable automatic login.
(3) After that, the OpenTerminal server that received the login request verifies the account information of the service provider (seller).
(4) If the account information of the service provider (seller) is verified as normal by the OpenTerminal server, the login result is transmitted to the OpenTerminal App of the service provider (seller).
(5) After normal login according to the account information of the service provider (seller), the service provider (seller) sets a service payment amount corresponding to the service provided to the payer and enters the service payment amount into the OpenTerminal App of the service provider (seller).
(6) Subsequently, the service payment amount information entered by the service provider (seller) is transmitted to the OpenTerminal server, and a request is made to generate a QR code to provide the service payment amount information to the payer.
(7) Accordingly, the OpenTerminal server generates a QR code image which may be provided to the payer, and information included in the QR code may include a store-specific value, order number (bill number), and payment amount information.

In this case, the order number (bill number) included in the QR code may be generated as a unique value each time the QR code is generated in order to verify the QR code, and in particular, the order number (bill number) is information that is available for only 3 minutes after the generation time and is a number which is can be checked for the time of issuance later because the server has information about the time of issuance after issuance.

That is, the specific reason why the order number (bill number) is needed in the QR code at this stage is that a value which enables the QR code session generated by the service provider (seller) to be linked to the payer's terminal is transmitted to achieve transmission of the bill, and when payment is completed for the corresponding order number (bill number) through PG, it is notified again that the payment is complete for the corresponding order number (bill number), and the payment completion is notified again to the seller's terminal. Therefore, the order number (bill number) is a unique value that is absolutely necessary for implementing the QR code-based bill-linked PG service method of the present invention.
(8) The QR code image information generated by the OpenTerminal server to include the above-described information is then transmitted to the OpenTerminal App of the service provider (seller).
(9) The OpenTerminal App of the service provider (seller) generates the received QR code image in the OpenTerminal App and displays the QR code image.
(10) After that, the user (payer) runs his/her own camera app on the user's (payer's) mobile device.
(11) The camera app executing on the user's (payer's) mobile device scans the QR code displayed on the service provider's (seller's) mobile device (OpenTerminal App).
(12) When the user (payer) scans the QR code displayed on the service provider's (seller's mobile device (OpenTerminal App) using the camera app, the payment page (bill page) implemented on the OpenTerminal server is accessed via the mobile browser. In this case, the information requested from the OpenTerminal server includes not only the QR code information generated by the OpenTerminal server in (7), but also the information contained in the QR code, such as the store-specific value, order number (bill number), and payment amount, of which verification is requested.
(13) When the verification is requested, the OpenTerminal server verifies a variety of information contained in the transmitted QR code. The OpenTerminal server may verify whether a dynamic authentication value is generated by a corresponding store in addition to the store-specific value, the order number (bill number), and the payment amount information, and verify whether the transmitted order number (bill number) is within the available time (within 3 minutes of generation).

In this case, in preparation for a case where the payment QR code is a screenshot or the order number (bill number) is stolen and used, the OpenTerminal server verifies the order number (bill number) to check whether the QR code is a QR code normally generated and whether the QR code is within the available time after generation (within 3 minutes after generation). If payment has already been completed for the order number (bill number), the OpenTerminal server treats the order number (bill number) as the payment being unavailable.
(14) After the OpenTerminal server has verified the QR code containing a variety of information, the OpenTerminal server transmits service provider (seller) information, order number (bill number), payment amount, or the like to the user (payer) mobile device.
(15) When the verification result information for the QR code is transmitted to the user's (payer's mobile device, the service provider (seller) information is displayed on the mobile browser of the user (payer), and more specifically, the service provider's (seller's photo, transaction number, payment amount, order number (bill number), or the like may be displayed in detail.
(16) The user (payer) directly checks the service provider's (seller's photo, transaction number, payment amount, order number (bill number), or the like displayed on his/her mobile device, and if there is no problem, enters the user (payer) information into the mobile browser of the user (payer). The information entered in this case may include the cardholder's name, mobile phone number, or the like, and the user (payer) information entered once may be automatically exposed in another payment process in the future through an information saving function.
(17) When the user (payer) enters his/her payment information, payment PG company information including the payer information is requested to the OpenTerminal server.
(18) When the payment information of the user (payer) is transmitted to the OpenTerminal server, the OpenTerminal server verifies information of the payment PG company, which may include information such as site code and certificate.
(19) The payment PG company information may be transmitted from the OpenTerminal server to the user's (payer's mobile device, and the payment PG company information included in this case may include PG access URL, return URL after payment (open bill site to be redirected after payment is completed), order number (bill number), product name, payment amount, name, phone number, site code, certificate, etc.
(20) When the payment PG company information is received by the mobile browser of the user (payer), the mobile browser of the user (payer) redirects the information to the payment page of the payment PG company.
(21) Afterwards, a card payment is requested to the PG server by the mobile browser of the user (payer). In this case, the requested card payment page may include a return URL after payment (an open bill site to be redirected after payment is completed), order number (bill number), product name, payment amount, name, phone number, site code, certificate, etc.
(22) When the request for the card payment page is transmitted to the PG server, the PG server transmits a page where the user is able to select a card for payment to the mobile browser of the user (payer). In this case, a list of selectable cards that are stored in advance such that mobile payment is possible on the user's (payer's) mobile device is provided in connection.

That is, in the existing QR code payment process, only when the service provider (seller) and the user (payer) are using an app from the same card company or bank, payment is possible using the corresponding app. However, according to the QR code-based bill-lined PG service system and service method of the invention, when the PG server requests a payment page from the user's (payer's mobile device, the payment information (card, pay service, transfer, etc.) that is pre-stored in the user's (payer's mobile device is linked such that the user (payer) is able to make selection, thereby enabling payment using an open bill that allows various mobile payments.
(23) Thereafter, the user (payer) may freely select a card, a pay service, etc. he/she prefers for payment using his/her mobile browser.
(24) In addition, the user (payer) can enter the card number selected for payment in his/her mobile browser or select app card payment. At this time, according to the user's (payer's) selection, a page for entering the card number in the mobile browser may be called or the app card can be directly linked.

### When a User (Payer) Enters a Card Number to Make a Payment

(25-1) The user (payer) requests payment with a card he or she wishes to pay with to the PG company from his or her mobile browser. In this case, the user (payer) directly enters a card number into the mobile browser or transmits pre-stored card information to the PG server. The PG server requests payment from a card company using the received card payment information.
(26-1) Afterwards, when the card company transmits the payment result to the PG server, the PG server transmits the payment result of the corresponding card to the user's (payer's) mobile browser. In this case, the order number (bill number), PG company payment number, PG company payment approval number, payment amount, payment card, installment terms, etc. may be transmitted.

### When a User (Payer) Makes a Payment Using an App Card Saved on a Mobile Device

(25-2) When the user (payer) selects app-card payment on the mobile browser, an app card is called via the PG company's webpage (when called, the order number (bill number), payer information, payment amount, etc. are transmitted together), and the app card requests payment from the card company's server.
(26-2) The card company transmits the payment result of the corresponding card to the app card running on the user's (payer's) mobile browser via the PG company, and in this case, the order number (bill number), PG company payment number, PG company payment approval number, payment amount, payment card, installment terms, etc. may be transmitted.
(27) When the payment result using the selected card or the payment result using the app card is received in the user's (payer's) mobile browser, the user's (payer's) mobile browser retransmits the PG payment result to the open bill site (retransmits to the return URL address after payment).
(28) After that, the payment result information is transmitted to the OpenTerminal server, and information included in the payment result information may include information such as order number (bill number), PG payment number, PG approval number, payment amount, payment card, and installment terms, or the like, which have been continuously included in the previous payment process.
(29) The OpenTerminal server saves the payment information.
(30) The OpenTerminal server transmits the payment information to the user's (payer's) mobile browser.
(31) In addition, the OpenTerminal server transmits the payment completion information to the OpenTerminal App of the service provider (seller), thereby ending the QR code-based bill-linked PG service method.

In addition, if the number of people paying in installments is entered together with the payment amount in step (5), a bill for payment in installments may be generated, and if the payer pays in installments by the QR bill for the divided amount with his or her smartphone, step (31) may be notified multiple times, or if all people paying in installments have paid in full, it may be notified at once.

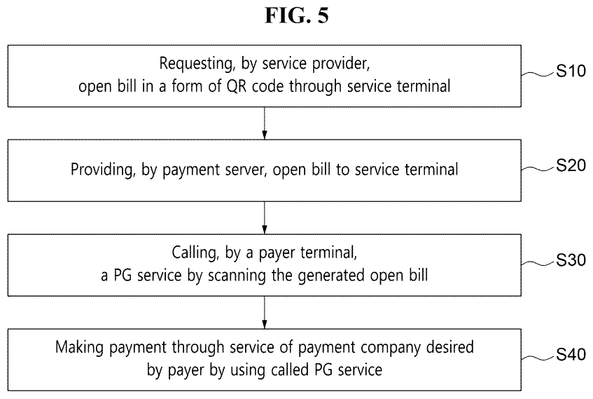

FIG. 5 is a flowchart of a QR code-based bill-linked PG service method according to an embodiment of the invention.

Referring to FIG. 5, the QR code-based bill-linked PG service method may include: a step S10 of requesting, by a service provider, an open bill in a form of a QR code through a service terminal, a step S20 of providing, by a payment server, the open bill to the service terminal, a step S30 of calling, by the payer terminal, a PG service by scanning the generated open bill, and a step S40 of making payment through the service of a payment company desired by the payer using the called PG service.

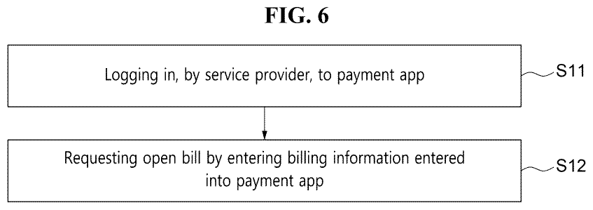

FIG. 6 is a flowchart of a step of requesting, by a service provider, an open bill in a form of a QR code through a service terminal according to an embodiment of the present invention.

Referring further to FIG. 6, the step S10 in the flowchart of FIG. 5 of requesting, by a service provider, an open bill in a form of a QR code through the service terminal may include a step S11 of logging in, by the service provider, to a payment app and a step S12 of inputting billing information into the payment app and requesting an open bill.

First, in the step S11 of logging in, by the service provider, to the payment app, the service provider may be arranged to execute the payment app installed in the service terminal 1100 and log in thereto. When the service provider logs in to the payment app, the payment server 1200 may verify a relevant account and provide the login result to the service terminal 1100.

Next, in the step S12 of inputting billing information into the payment app and requesting an open bill, the service provider may be arranged to input the billing information into the payment app of the service terminal 1100 and request the open bill from the payment server 1200. In this case, the billing information may be arranged to include payment amount, service provider information, number of payers, billing amount by payer, etc. In addition, it may be arranged to recognize that the billing amount by payer is equal if the billing amount by payer is blank.

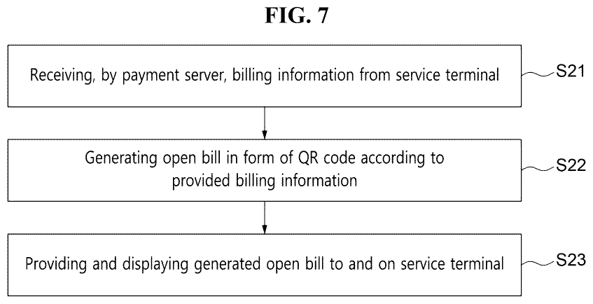

FIG. 7 is a flowchart of the step of providing, by the payment server, an open bill to the service terminal according to an embodiment of the present invention.

Referring to FIG. 7, the step S20 in the flowchart of FIG. 5 of providing, by the payment server, an open bill to the service terminal may include a step S21 of receiving, by the payment server, billing information from the service terminal, a step S22 of generating the open bill in a form of a QR code according to the received billing information, and a step S23 in which the generated open bill is provided to and displayed on the service terminal.

In the step S21 of receiving, by the payment server, billing information from the service terminal, the communication section 1220 of the payment server 1200 may be arranged to receive the billing information through the payment app of the service terminal 1100.

Next, in the step S22 of generating the open bill in a form of a QR code according to the received billing information, the generation section 1210 of the payment server 1200 may be arranged to generate the open bill in a form of a QR code according to the billing information. In this case, the open bill may be arranged to include information such as service provider information, such as the store SEQ or store dynamic authentication value, total payment amount, billing amount to be paid by each payer, or the like.

Next, in the step S23 in which the generated open bill is provided to and displayed on the service terminal, the payment server 1220 may provide the open bill as a QR code image to the service terminal 1100 through the communication section 1220 to display the open bill.

Next, in the step S30 in the flowchart of FIG. 5 of calling, by the payer terminal, the PG service by scanning the generated open bill, the payer may run a camera app of the payer terminal 1300 to scan the open bill in the form of a QR code to make an inquiry for the payment bill.

In the step S30 in the flowchart of FIG. 5 of calling, by the payer terminal, the PG service by scanning the generated open bill, the open bill may be arranged to be viewed the number of payers entered, or may be arranged to be valid only for a preset time.

By being arranged in this way, it is possible to prevent the problem of duplicate payment by scanning another person's open bill that has already been paid.

After the step S30 in the flowchart of FIG. 5 of calling, the payer terminal, the PG service by scanning the generated open bill, a step of verifying the open bill may be further included.

In the step of verifying the open bill, it is possible to prevent QRishing by verifying the store SEQ, dynamic token value, payment amount, etc.

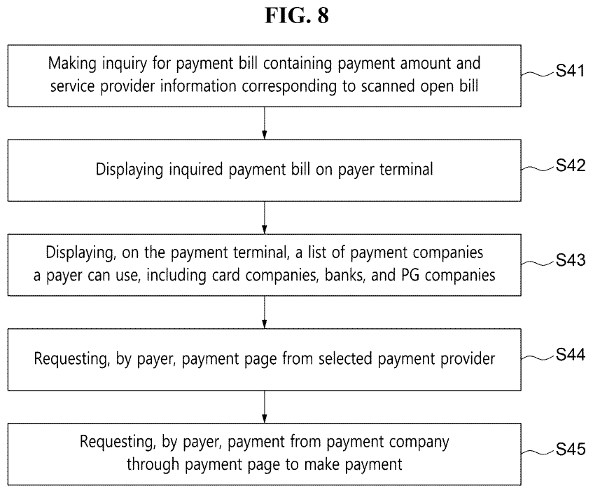

FIG. 8 is a flowchart of a step of making a payment through the service of a payment company desired by a payer using the called PG service according to an embodiment of the invention.

Referring to FIG. 8, the step S40 in the flowchart of FIG. 5 of making payment through the service of the payment company desired by the payer using the called PG service may include a step S41 of making an inquiry for a payment bill containing a payment amount and service provider information corresponding to the scanned open bill, a step S42 of displaying the inquired payment bill on the payer terminal, a step S43 of displaying, on the payer terminal, a list of at least one of payment companies that the payer is able to use, such as card companies, banks, financial transaction providers, and virtual currency transaction providers, a step S44 of requesting a payment page from a payment company selected by the payer, and a step S45 of requesting, by the payer, payment from the payment company through the payment page to make a payment.

In the step S41 of making an inquiry for the payment bill containing a payment amount and service provider information corresponding to the scanned open bill, it may be arranged that when the payer terminal 1300 scans the open bill, the inquiry unit 1231 makes an inquiry for a payment bill corresponding to the open bill. The payment bill may be arranged to include information such as service provider information, such as the store SEQ or store dynamic authentication value, total payment amount, billing amount to be paid by each payer, or the like.

In the step S41 of making an inquiry for a payment bill containing a payment amount and service provider information corresponding to the scanned open bill, the payment amount of the payment bill may be divided equally according to the number of payers entered into the payment app, or the payment amount of the payment bill may be provided in a divided manner according to the bill amount for each payer entered in the payment app.

Next, in the step S42 of displaying the inquired payment bill on the payer terminal, the payment bill inquired by the inquiry unit 1231 may be displayed on the payer terminal 1300.

In addition, the payment bill may be provided such that payer information may be additionally entered into the payment bill if necessary. The information may include information such as the payer's name and phone number.

In addition, a payment button may be displayed together with the payment bill such that the payer is able to express his/her intention to confirm the payment bill and make a payment.

Next, in the step S43 of displaying, on the payer terminal, a list of at least one of payment companies that the payer is able to use, such as card companies, banks, financial transaction providers, and virtual currency transaction providers, the list unit 1232 may be arranged to list and display payment companies that the payer is able to pay, such as card companies, banks, and PG companies.

In particular, the list unit 1232 may be arranged to list payment companies according to the default language of a browser set in the payer terminal 1300 or a language corresponding to the GPS location of the payer terminal.

For example, the list unit 1232 may be arranged to automatically list and display payment companies capable of making payments in China when the GPS location of the payer terminal 1300 is in the United States.

In addition, the list unit 1232 may be arranged to list Korean payment companies capable of making payments in priority when the default language of the browser is Korean even when the GPS location of the payer terminal 1300 is in the United States.

In this way, the list unit 1232 may enable the payer to select a payment company that he/she wants to use. In addition, the payment companies may include card companies, banks, PG companies, etc.

In the step S44 of requesting a payment page from a payment company selected by the payer, the payment unit 1233 may be arranged to guide a payer to proceed with payment through the service of the payment company selected by the payer.

Specifically, the payment unit 1233 may be arranged to provide payment-related information to a corresponding payment company such that the payer is able to make payment by utilizing the service of the payment service provider, such as an app, when the payer selects a desired payment service provider from the list unit 1232.

For example, when the payer selects payment with a KB card from the list unit 1232, the payment unit 1233 may provide payment information to KB such that the KB app installed on the payer terminal 1300 is executed to execute a payment page to pay the billing amount to the service provider.

Next, in the step S45 of requesting, by the payer, payment from the payment company through the payment page to make a payment, payment is completed using the service of the payment company selected by the payer, and a notification that payment has been completed is provided to the service terminal 1100 and the payer terminal 1300 and payment information is saved.

In a conventional process for making a payment by scanning a payment QR code with a mobile app card in a PC shopping mall, in the case of online shopping malls, the service provider selects a product while knowing which website it is, checks purchase details (bill), and then clicks a payment button. Further, when a payer selects a card on a PG page displayed, is redirected to the selected card company's webpage, checks general payment, app card payment, Samsung Pay, or the like on the card company's webpage, and selects the app card payment, a QR code is displayed. When a user runs a payment app on his/her smartphone, the app card scans the QR code with a camera and perform biometric authentication to complete payment, and the purchase is marked as complete on the PC.

However, unlike online, it was not easy to pay in this way offline. In particular, it is difficult for restaurants to ask customers in advance which payment app they want to pay with, and it is also difficult for customers to approve payment on their smartphones without checking the contents of the QR code requesting payment, thus making it easy to fall prey to a QR code substitution attack called “QRishing”.

On the other hand, according to the invention described above, in an offline situation, when a payer proceeds with payment using the payment terminal 1300 such as a smartphone, the payer is able to check the details of the payment through the payer terminal 1300 without being notified of or selecting the payment app installed on the payer terminal 1300 in advance, making it possible to make payment safely through payment apps already installed on the payer terminal 1300.

In addition, if the conventional QR code displayed between terminals is used for payment authentication, it is vulnerable to payment authentication attacks such as QRishing. However, if the QR code displayed between terminals is used for bill verification as in the present invention, the payer is not exposed to QRishing because the payer is able to check the billing details with the biller in advance and pay safely through the payment app installed on his/her smartphone.

The effect of the present invention according to the above configuration is that the payer does not need to inform the service provider of the payment app installed on his/her smartphone in advance, and may proceed with payment through the payment app installed on his/her smartphone after checking the bill on his/her smartphone.

In particular, if the conventional QR code displayed between terminals is used as a payment authentication method, it is vulnerable to payment authentication attacks such as QRishing, but if the QR code displayed between terminals is used to check a bill, the payer may check the billing details with the biller in advance and make payment safely through the payment app installed on the payer's smartphone, which has the advantage of not being exposed to QRishing.

The effects of the present invention are not limited to the above effects, but are to be understood to include all effects that can be deduced from the detailed description of the invention or the composition of the invention described in the claims of the patent.

The foregoing description of the present invention, although illustrated by limited drawings, is for illustrative purposes only, and a person having ordinary skill in the art to which the present invention pertains will understand that the present invention can be easily modified into other specific forms without changing the technical idea or essential characteristics of the present invention. Therefore, it should be understood that the embodiments described above are illustrative in all respects and not restrictive. For example, each component described as a single type may be implemented in a distributed manner, and likewise, components described as distributed may be implemented in a combined manner. In addition, the described techniques may be performed in a different order than the described method.

Although certain embodiments and implementations have been described herein, other embodiments and modifications will be apparent from this description. Accordingly, the inventive concepts are not limited to such embodiments, but rather to the broader scope of the appended claims and various obvious modifications and equivalent arrangements as would be apparent to a person of ordinary skill in the art.

1. A Quick Response (“QR”) code-based bill-linked Payment Gateway (“PG”) service system comprising:
a service terminal configured to receive billing information and request generation of an open bill in a form of a QR code;
a payment server configured to generate the requested open bill and provide the requested open bill to the service terminal; and
a smartphone-type payer terminal configured to scan the open bill displayed on the service terminal,
wherein the payment server is configured to verify a payment bill linked to the open bill when the payer terminal scans the open bill, and then allow a mobile PG service to be displayed on the payer terminal such that a payer is able to make mobile payment using a service of a payment company desired by the payer.

2. The QR code-based bill-linked PG service system of claim 1, wherein the payment server includes:
a generation section configured to generate the open bill in the form of a QR code;
a communication section configured to receive the billing information from the service terminal and provide the open bill to the service terminal; and
a payment section configured to provide the PG service when the payer terminal scans the above open bill.

3. The QR code-based bill-linked PG service system of claim 2, wherein the billing information includes a payment amount and service provider information.

4. The QR code-based bill-linked PG service system of claim 2, wherein the payment section includes:
an inquiry unit configured to display the payment bill including the payment amount and the service provider information corresponding to the open bill on the payer terminal;
a list unit configured to list and display one or more of payment companies which the payer is able to pay with, including card companies, banks, financial transaction providers, and virtual currency transaction providers; and
a payment unit configured to make payment through a service of a payment company selected by the payer.

5. The QR code-based bill-linked PG service system of claim 4, wherein the list unit is configured to list the payment companies according to a default language of a browser set in the payer terminal or a language corresponding to a Global Positioning Service (“GPS”) location of the payer terminal.

6. A Quick Response (“QR”) code-based bill-linked Payment Gateway (“PG”) service method comprising:
requesting, by a service provider, an open bill in a form of a QR code through a service terminal;
providing, by a payment server, the open bill to the service terminal;
calling, by a payer terminal, a PG service by scanning the generated open bill; and
making payment through a service of a payment company desired by the payer using the called PG service.

7. The QR code-based bill-linked PG service method of claim 6, wherein the requesting, by the service provider, the open bill in a form of a QR code through the service terminal includes:
logging in, by the service provider, to a payment app; and
requesting the open bill by inputting the billing information to the payment app.

8. The QR code-based bill-linked PG service method of claim 6, wherein the providing, by the payment server, the open bill to the service terminal includes:
receiving, by the payment server, the billing information from the service terminal;
generating the open bill in the form of the QR code according to the provided billing information; and
providing and displaying the generated open bill to and on the service terminal.

9. The QR code-based bill-linked PG service method of claim 6, wherein the making payment through the service of the payment company desired by the payer using the called PG service includes:
making an inquiry for a payment bill containing a payment amount and service provider information, corresponding to the scanned open bill;
displaying the inquired payment bill on the payer terminal;
displaying, on the payer terminal, a list of at least one of payment companies that the payer is able to use, including card companies, banks, financial transaction providers, and virtual currency transaction providers;
requesting, by the payer, a payment to the selected payment company; and
requesting, by the payer, payment to the payment company through the payment page and making payment.

10. The QR code-based bill-linked PG service method of claim 9, wherein the displaying, on the payer terminal, the list of at least one of payment companies that the payer is able to use further includes listing the payment companies according to a default language of a browser set in the payer terminal or a language corresponding to a Global Positioning Service (“GPS”) location of the payer terminal.

11. The QR code-based bill-linked PG service method of claim 9, wherein, in making an inquiry for a payment bill containing the payment amount and the service provider information corresponding to the scanned open bill, the payment amount of the payment bill is equally divided according to a number of payers entered in the payment app.

12. The QR code-based bill-linked PG service method of claim 9, wherein, in making an inquiry for a payment bill containing the payment amount and the service provider information corresponding to the scanned open bill, the payment amount of the payment bill is provided in a divided manner according to a billing amount for each payer entered in the payment app.

13. The QR code-based bill-linked PG service method of claim 6, wherein, in calling, by the payer terminal, a PG service by scanning the open bill generated, the open bill is arranged to be viewed by only a number of payers
